(19) United States
(12) Patent Application Publication
(10) Pub. No.: US 2025/0212039 A1
(43) Pub. Date: Jun. 26, 2025

(54) METHOD AND APPARATUS OF SUPPORTING QUALITY OF EXPERIENCE (QoE) MEASUREMENT COLLECTION

(71) Applicant: LENOVO (BEIJING) LIMITED, Beijing (CN)

(72) Inventors: Mingzeng DAI, Shanghai (CN); Lianhai WU, Beijing (CN); Congchi ZHANG, Shanghai (CN); Le YAN, Shanghai (CN); Xiaoying XU, Beijing (CN)

(21) Appl. No.: 18/852,167

(22) PCT Filed: May 6, 2022
(86) PCT No.: PCT/CN2022/091153

§ 371 Date: Sep. 27, 2024

(51) Int. Cl. H04W 24/10

(52) U.S. Cl. CPC H04W 24/10

(57) ABSTRACT

Embodiments of the present application relate to a method and apparatus of supporting quality of experience (QoE) measurement collection. An exemplary method may include: determining at least one of a master node (MN) leg or a secondary node (SN) leg to be used for QoE measurement reporting; and transmitting to a user equipment (UE) information indicating the at least one of the MN leg or the SN leg to be used for QoE measurement reporting.

### TECHNICAL FIELD

Embodiments of the present application generally relate to wireless communication technology, especially to a method and apparatus of supporting quality of experience (QoE) measurement collection.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In 3GPP release (Rel)-17, the basic mechanism for NR QoE is specified. Since NR-dual connectivity (DC) is an important commercial deployment scenario for 5G networks, it is critical to support NR-DC in the NR QoE framework. Therefore, QoE in Rel-18 will support QoE measurement configuration and measurement reporting for NR-DC scenario, as agreed below in RP-213159:
Specify the QoE configuration, and measurement reporting over MN/SN for NR-DC architecture and specify the QoE measurement reporting over the other DC leg in order to maintain the reporting continuity.

Given the above, the industry desires technology to support QoE measurement collection for NR-DC, e.g., supporting flexible QoE measurement reporting leg configuration and selection, and QoE measurement reporting leg switching with reporting continuity in NR-DC, and supporting QoE measurement collection pause and resume etc.

### SUMMARY OF THE APPLICATION

One objective of the embodiments of the present application is to provide a technical solution of support QoE measurement collection, e.g., a method and apparatus of supporting QoE measurement collection for NR-DC.

Some embodiments of the present application provide a radio access network (RAN) node, e.g., a master node (MN) or a secondary node (SN), which includes: a transceiver; and a processor coupled to the transceiver, wherein the processor is configured to: determine at least one of a MN leg or a SN leg to be used for QoE measurement reporting; and transmit, via the transceiver, to a user equipment (UE) information indicating the at least one of the MN leg or the SN leg to be used for QoE measurement reporting.

Some other embodiments of the present application provide a method, which may be performed in a RAN node, e.g., a MN or SN, and the method includes: determining at least one of a MN leg or a SN leg to be used for QoE measurement reporting; and transmitting to a UE information indicating the at least one of the MN leg or the SN leg to be used for QoE measurement reporting.

According to some embodiments of the present application, the RAN node is a MN, and the processor is further configured to: determine at least one signalling radio bearer (SRB) type for QoE measurement reporting in response to QoE measurement activation information from a core network or QoE measurement configuration information from an operation administration and maintenance (OAM).

In some embodiments of the present application, in the case that the SN leg is used for QoE measurement reporting, the processor is configured to: transmit to a SN a request of SRB establishment of a corresponding SRB type for QoE measurement reporting.

In some embodiments of the present application, the request of SRB establishment of the corresponding SRB type for QoE measurement reporting is transmitted in a Xn message during a SN addition procedure or after the SN addition procedure.

In some embodiments of the present application, the processor is configured to: receive from the SN a response to the request of SRB establishment of the corresponding SRB type for QoE measurement reporting, indicating an admitted SRB type.

In some embodiments of the present application, the processor is configured to: transmit to the SN a service type or measurement configuration application layer identifier for QoE measurement reporting.

In some embodiments of the present application, the at least one SRB type includes one of MN terminated split SRB4, SN terminated split SRB4, SRB3 and SRB terminated between UE and SN for QoE measurement reporting with a lower priority than SRB3. The processor is configured to: receive packet data convergence protocol (PDCP) protocol data units (PDU)s of a QoE measurement report from the SN in the case of the MN terminated split SRB4 being used for QoE measurement reporting.

In some embodiments of the present application, the processor is configured to: receive radio resource control (RRC) segments of a QoE measurement report from the SN, and concatenate the received RRC segments; or receive concatenated RRC segments of the QoE measurement report from the SN.

In some embodiments of the present application, in the case that the MN leg is used for QoE measurement reporting, the at least one SRB type includes one of MN terminated split SRB4, SN terminated split SRB4 and SRB4.

In some embodiments of the present application, the processor is configured to: transmit PDCP PDUs of a QoE measurement report to the SN in the case of the SN terminated split SRB4 being used for QoE measurement reporting.

According to some other embodiments of the present application, the RAN node is a SN, and the processor is configured to: determine at least one SRB type for QoE measurement reporting in response to QoE measurement activation information from a MN or QoE measurement configuration information from an OAM.

In some embodiments of the present application, the QoE measurement activation information is transmitted in a Xn message during a SN addition procedure or after the SN addition procedure.

In some embodiments of the present application, the processor is configured to: select the UE in response to the QoE measurement configuration information from the OAM.

In some embodiments of the present application, the at least one SRB type includes one of MN terminated split SRB4, SN terminated split SRB4, SRB3 or SRB terminated between UE and SN for QoE measurement reporting with a lower priority than SRB3. According to some embodiments of the present application, the processor is configured to: transmit a request of SN terminated split SRB establishment to the MN in the case of SN terminated split SRB4 to be used for QoE measurement reporting. According to some other embodiments of the present application, the processor is configured to: receive PDCP PDUs of a QoE measurement report from the MN in the case of SN terminated split SRB4 being used for QoE measurement reporting. According to some yet other embodiments of the present application, the processor is configured to: transmit PDCP PDUs of a QoE measurement report to the MN in the case of MN terminated split SRB4 being used for QoE measurement reporting.

In some embodiments of the present application, in response to the QoE activation information from the MN, the processor is configured to: transmit RRC segments of a QoE measurement report to the MN; or concatenate received RRC segments of the QoE measurement report and transmit the concatenated RRC segments to the MN.

In some embodiments of the present application, the information indicating the at least one of the MN leg or the SN leg to be used for QoE measurement reporting is separate from information on the at least one SRB type or is indicated in the information on the at least one SRB type.

According to some embodiments of the present application, the RAN node is a MN, and the processor is configured to: transmit a pause indication to the UE to pause QoE measurement reporting in the case of both the MN and SN are overloaded for QoE measurement reporting.

In some embodiments of the present application, the processor is configured to: receive QoE measurement reporting overload information from the SN. The QoE measurement reporting overload information is based on a service type or a measurement configuration application layer identifier. The QoE measurement reporting overload information is indicated in a Xn user plane protocol.

In some embodiments of the present application, the processor is configured to: transmit a resume indication to the UE to resume the QoE measurement reporting in the case that none of the MN and the SN or only one of the MN and the SN is overloaded for the QoE measurement reporting.

According to some embodiments of the present application, the RAN node is a MN, and the processor is configured to transmit a pause indication to the UE to pause SN QoE measurement reporting in response to a request of pause SN QoE measurement reporting.

In some embodiments of the present application, the request of pause SN QoE measurement reporting is based on a service type or a measurement configuration application layer identifier.

In some embodiments of the present application, the processor is configured to: transmit a resume indication to the UE to resume the SN QoE measurement reporting in response to a request of resume SN QoE measurement reporting. The request of resume SN QoE measurement reporting is based on a service type or a measurement configuration application layer identifier.

According to some embodiments of the present application, the processor is configured to: transmit a pause indication to the UE to pause QoE measurement reporting of a leg of the RAN node in response to the RAN node being overloaded for QoE measurement reporting.

In some embodiments of the present application, whether the RAN node being overloaded for QoE measurement reporting is based on a service type or a measurement configuration application layer identifier.

In some embodiments of the present application, the processor is configured to: transmit a resume indication to the UE to resume the QoE measurement reporting of the leg of the RAN node in response to the RAN node not being overloaded for QoE measurement reporting.

Some embodiments of the present application provide a UE, including: a transceiver; and a processor coupled to the transceiver. The processor is configured to: receive, via the transceiver, information indicating at least one of a MN leg or a SN leg to be used for QoE measurement reporting; and transmit to at least one of the MN or the SN a QoE measurement report via at least one SRB type according to the information indicating the at least one of the MN leg or the SN leg.

In some embodiments of the present application, in the case of SRB4 is used for QoE measurement reporting, the QoE measurement report is transmitted to the MN by using the MN leg; in the case of SRB3 or SRB terminated between UE and SN for QoE measurement reporting with a lower priority than SRB3 is used for QoE measurement reporting, the QoE measurement report is transmitted to the SN over the SN leg; in the case of MN terminated split SRB4 or SN terminated split SRB4 is used for QoE measurement reporting and both the MN leg and SN leg being used for QoE measurement reporting, the QoE measurement report is transmitted to the MN over the MN leg and to the SN over the SN leg; and in the case of the MN terminated split SRB4 or the SN terminated split SRB4 is used for QoE measurement reporting and one of the MN leg and the SN leg being used for QoE measurement reporting, the QoE measurement report is transmitted to corresponding one of the MN and the SN over the one of the MN leg and the SN leg.

In some embodiments of the present application, in the case of the QoE measurement report is transmitted to both the MN and the SN, the processor is configured to prioritize to transmit the QoE measurement report over a primary leg of the MN leg and the SN leg, or over a leg with a higher priority of the MN leg and the SN leg.

In some embodiments of the present application, in the case of the QoE measurement report is transmitted to both the MN and the SN and RRC segmentation is used, the processor is configured to transmit RRC segments of the QoE measurement report to one or both of the MN and the SN based on an indication on whether a part of RRC segments of the QoE measurement report is transmitted to the MN and other part of the RRC segments is transmitted to the SN is allowed.

In some embodiments of the present application, the processor is configured to pause QoE measurement reporting to the at least one of the MN and the SN in response to a pause indication to pause the QoE measurement reporting to the at least one of the MN and the SN. The processor is configured to resume QoE measurement reporting to the at least one of the MN and the SN in response to a resume indication to resume the QoE measurement reporting to the at least one of the MN and the SN.

Embodiments of the present application provide a method and apparatus of supporting QoE measurement collection, which can be applied in NR-DC scenarios. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a flow chart illustrating an exemplary procedure of a method of supporting QoE measurement collection according to some embodiments of the present application.

FIG. 3 is a flow chart of a procedure of QoE measurement collection in Scenario 1 according to some embodiments of the present application.

FIG. 4 is a flow chart of a procedure of QoE measurement collection in Scenario 2 according to some embodiments of the present application.

FIG. 5 is a flow chart of a procedure of QoE measurement collection in Scenario 3 according to some embodiments of the present application.

FIG. 6 is a flow chart of a procedure of QoE measurement collection in Scenario 4 according to some embodiments of the present application.

FIG. 7 illustrates a block diagram of an apparatus of supporting QoE measurement collection according to some embodiments of the present application.

FIG. 8 illustrates a block diagram of an apparatus of supporting QoE measurement reporting according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface, e.g., Xn interface as specified in 3GPP standard documents, and at least the MN is connected to the core network (CN).

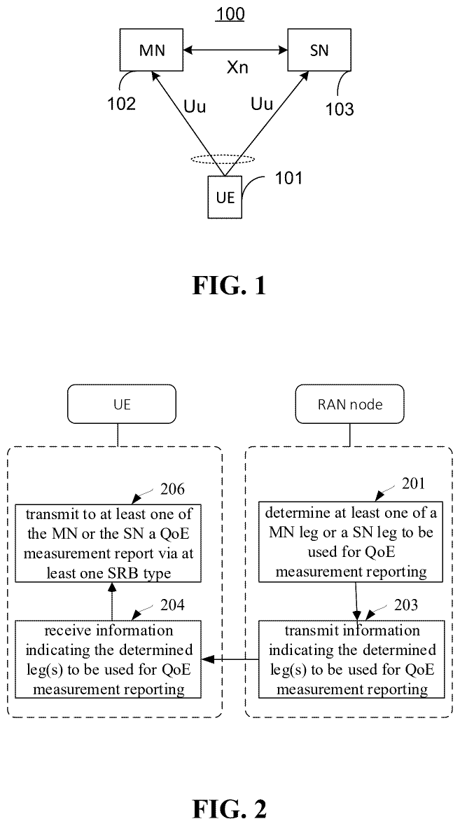

For example, FIG. 1 illustrates a schematic diagram of a wireless communication system 100 in accordance with some embodiments of the present application.

As shown in FIG. 1, the wireless communication system 100 may be a dual connectivity system 100 includes at least one user equipment (UE) 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via an interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1). The UE 101 may be configured to utilize resources provided by the MN 102 and the SN 103 to perform data transmission.

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The MN 102 refers to a radio access network node that provides a control plane connection to the core network. In an embodiment of the present application, in the E-UTRA-NR DC (EN-DC) scenario, the MN 102 may be an eNB. In another embodiment of the present application, in the next generation E-UTRA-NR DC (NGEN-DC) scenario, the MN 102 may be a next generation (ng)-eNB. In yet another embodiment of the present application, in the NR-DC scenario or the NR-E-UTRA DC (NE-DC) scenario, the MN 102 may be a gNB. A MN 102 may also be referred to as a master-NG-RAN (M-NG-RAN) node in some embodiments of the present application.

A MN leg may be referred to as a master cell group (MCG). The MCG may refer to a group of serving cells associated with the MN 102, and include a primary cell (PCell) and optionally one or more secondary cells (SCells). The PCell may provide a control plane connection to the UE 101.

The SN 103 may refer to a radio access network node without control plane connection to the core network but providing additional resources to the UE 101. In some embodiments of the present application, in the EN-DC scenario, the SN 103 may be an en-gNB. In some other embodiments of the present application, in the NR-DC scenario, the SN 103 may be a ng-eNB. In yet another embodiment of the present application, in the NR-DC scenario or the NGEN-DC scenario, the SN 103 may be a gNB. A SN 103 may also be referred to as a secondary-NG-RAN (S-NG-RAN) node in some embodiments of the present application.

A SN leg may be referred to as a secondary cell group (SCG). The SCG may refer to a group of serving cells associated with the SN, and include a primary secondary cell (PSCell) and optionally one or more SCells.

The PCell of the MCG and the PSCell of the SCG may also be referred to as a special cell (SpCell).

In addition, regarding QoE measurement collection activation and reporting, TS38.300 specifies the following:
“The feature is activated in the NG-RAN either by direct configuration from the OAM system (management-based activation), or by signalling from the OAM via the Core Network (signalling-based activation), containing UE-associated QoE configuration. One or more QoE measurement collection jobs can be activated at a UE per service type, and each QoE measurement configuration is uniquely identified by a QoE Reference.
For signalling-based QoE measurements, the OAM initiates the QoE measurement activation for a specific UE via the Core Network, and the NG-RAN node receives one or more QoE measurement configurations by means of UE-associated signalling. The QoE measurement configuration for signalling-based activation includes an application layer measurement configuration list and the corresponding information for QoE measurement collection, e.g., QoE Reference, service type, MCE IP Address, Slice Scope, Area Scope, MDT Alignment Information and the indication of available RAN visible QoE metrics. Each application layer measurement configuration is encapsulated in a transparent container. The NG-RAN node forwards the corresponding QoE measurement configuration(s) to the UE in a downlink RRC message containing AppLayerMeasConfig, as specified in TS38.331 [12].
For management-based QoE measurement activation, the OAM sends one or more the QoE measurement configurations to the NG-RAN node. The QoE measurement configuration for management-based activation also includes an application layer measurement configuration list and the corresponding information for QoE measurement collection. Each application layer measurement configuration is encapsulated in a transparent container. The NG-RAN node selects UE(s) that meet the required QoE measurement capability, Area Scope and Slice Scope.
The UE reports QoE measurement results to the NG-RAN node in an uplink RRC message, as specified in TS38.331 [12]. The NG-RAN node transmits the QoE report and the corresponding QoE Reference ID to the MCE.
The QoE measurement collection is handled by application layer measurement configuration and measurement reporting, supported in RRC_CONNECTED state only. Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's higher layer are encapsulated in a transparent container and sent to the network in the MeasurementReportAppLayer message, as specified in TS 38.331 [12]. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. A measConfigAppLayerId conveyed in the RRC signalling is used to identify the application layer measurement configuration and report between the gNB and the UE. The RRC identifier is mapped to the QoE Reference in the gNB. The application layer measurement report is forwarded to OAM together with the QoE Reference. gNB can release one or multiple application layer measurement configurations from the UE in one RRCReconfiguration message at any time. The UE may additionally be configured by the gNB to report when a QoE measurement session starts or stops for a certain application layer measurement configuration.”

Thus, the application layer measurement configuration received by the gNB from the OAM or CN is encapsulated in a transparent container in Rel-17, which is forwarded to a UE as application layer configuration in a RRCReconfiguration message (there can be multiple configurations in the same message). Application layer measurement reports received from UE's application layer are encapsulated in a transparent container and sent to the network in a MeasurementReportAppLayer message. In order to allow the transmission of application layer measurement reports which exceed the maximum PDCP SDU size, segmentation of the MeasurementReportAppLayer message may be enabled by the gNB.

TS 38.300 also specifies handling of QoE measurement collection during RAN overload as follows:
“QoE Measurement Collection pause/resume procedure is used to pause/resume the reporting for all QoE reports or to pause/resume QE measurement reporting per QoE configuration in a UE in RAN overload situation.
gNB can use the RRCReconfiguration message to temporarily stop application layer measurement reports associated to one or multiple application layer measurement configurations from being sent from the UE to the gNB. When the UE receives the QoE pause indication, UE temporarily stores application layer measurement reports in AS layer. When the UE receives the QoE resume indication, UE sends the stored application layer measurement reports to the gNB.”

It can be seen that, in Rel-17, a QoE measurement collection pause/resume procedure is used to pause and resume the reporting for all QoE reports or to pause and resume QoE measurement reporting per QoE configuration in a UE in the network overload situation.

According to RP-213159, the support for QoE measurement configuration and measurement reporting over MN/SN for NR-DC scenario should be settled in Rel-18. However, in a NR-DC scenario, both the MN leg (or MCG) and SN leg (or SCG) can be used for QoE measurement collection. Since the data volume of a QoE measurement report may be large, flexible QoE measurement reporting leg configuration, selection and switching, e.g., based on the network overload status is desirable. Thus, several issues should be solved to support QoE measurement collection in NR-DC scenarios, which includes but is not limited to: how to support flexible QoE measurement reporting leg configuration and selection, how to support QoE measurement reporting leg switching with reporting continuity in NR-DC, and how to handle QoE measurement pause and resume function in NR-DC.

Given the above, embodiments of the present application provide technical solutions of supporting QoE measurement collection, especially for solving issues on supporting QoE measurement collection in NR-DC.

FIG. 2 is a flow chart illustrating an exemplary procedure of a method of supporting QoE measurement collection according to some embodiments of the present application. Although the method is illustrated in a system level by a RAN node in the network side, e.g., a MN or a SN and a remote apparatus in the remote side, e.g., a UE, persons skilled in the art should understand that the method implemented in the RAN node and UE can be separately implemented and/or incorporated by other apparatus with the like functions.

Referring to FIG. 2, in a NR-DC scenario, a RAN node, e.g., a MN or SN will determine at least one of a MN leg or a SN leg to be used for QoE measurement reporting (or QoE measurement collection reporting) in step 201. For example, in the case of the RAN node being a MN, the MN may determine at least one of a MN leg or a SN leg to be used for QoE measurement reporting in response to QoE measurement (or QoE measurement collection) being activated either by direct configuration from the OAM (i.e., management-based activation), or by signalling from the OAM via the CN (i.e., signalling-based activation), containing UE-associated QoE configuration. In the case of the RAN node being a SN, the SN may determine at least one of a MN leg or a SN leg to be used for QoE measurement reporting in response to QoE measurement collection being activated either by direct configuration from the OAM (i.e., management-based activation), or by QoE measurement activation information from the MN (i.e., signalling-based activation). In the signalling-based activation, the MN may send the QoE measurement activation information to the SN in response to signalling from the OAM via the CN (i.e., from the CN), containing UE-associated QoE configuration.

In some embodiments of the present application, the RAN node will also determine at least one SRB type used for QoE measurement reporting in response to the QoE measurement activation information, e.g., the direct configuration from the OAM or signalling containing UE-associated QoE configuration from the CN etc. For example, the RAN node may determine MN terminated split SRB4 or SN terminated split SRB4 for QoE measurement reporting over both the MN leg and SN leg, and the QoE measurement reporting will be transmitted over the MN leg to the MN and over the SN leg to the SN. In another example, the RAN node may determine SRB4, or MN terminated split SRB4 or SN terminated split SRB4 for QoE measurement reporting over the MN leg to the MN. In yet another example, the RAN node may determine SRB3, or SRB3-like, or MN terminated split SRB4 or SN terminated split SRB4 for QoE measurement reporting over the SN leg to the SN. Regarding SRB3-like, it is SRB terminated between UE and SN for QoE measurement reporting with a lower priority than SRB3, e.g., SRB 5. In addition, when both the MN leg and SN leg are used for QoE measurement reporting, the SRB types for the MN leg and SN leg may be the same or different. For example, SRB4 may be configured for the MN leg while SRB3 or SRB3-like may be configured for the SN leg, so that the QoE measurement report can be transmitted to the MN via the MN leg and to the SN via the SN leg.

Persons skilled in the art should well know that a QoE measurement reporting leg is associated with a RAN node, when the MN leg and/or SN leg is determined for the QoE measurement reporting, to which RAN node(s), e.g., MN and/or SN the QoE measurement reporting will be transmitted is also determined in some embodiments of the present application. However, for MN terminated split SRB4, the SN needs to forward the received QoE measurement reporting (partial or the entire) to the MN; and for SN terminated split SRB4, the MN needs to forward the received QoE measurement reporting (partial or the entire) to the SN.

The RAN node will transmit to the UE information indicating the determined leg(s) to be used for QoE measurement reporting (or to which RAN node(s) the QoE measurement reporting is transmitted) in step 203. For example, the MN may transmit to the UE the information indicating that both the MN leg and SN leg are used for QoE measurement reporting, or only the MN leg is used for QoE measurement reporting, or only the SN leg is used for QoE measurement. In another example, the SN may transmit to the UE the information indicating that both the MN leg and SN leg are used for QoE measurement reporting, or only the MN leg is used for QoE measurement reporting, or only the SN leg is used for QoE measurement reporting etc.

The information indicating the determined leg(s) to be used for QoE measurement reporting can directly indicate which leg(s) is to be used for QoE measurement reporting in some embodiments of the present application. The SRB type can be indicated to the UE separate from the information indicating the determined leg(s) to be used for QoE measurement reporting in the same or different signallings. In some other embodiments of the present application, the information indicating the determined leg(s) to be used for QoE measurement reporting may imply which leg(s) is to be used for QoE for reporting, e.g., by indicating the SRB type for QoE measurement reporting. That is, the information indicating the determined leg(s) to be used for QoE measurement reporting is the information on the SRB type. For example, in the case that MN terminated split SRB4 or SN terminated split SRB4 is indicated to be used for QoE measurement reporting, it means that QoE measurement reporting can be transmitted over both the MN leg and SN leg. In the case that SRB3 or SRB3-like is indicated to be used for QoE measurement reporting, it means that QoE measurement reporting can be transmitted only over the SN leg. In the case that SRB4 is indicated to be used for QoE measurement reporting, it means that QoE measurement reporting can be transmitted only over the MN leg.

The UE will receive the information indicating the at least one of the MN leg or the SN leg to be used for QoE measurement reporting in step 204. After performing QoE measurement collection, the UE will transmit the QoE measurement report via at least one SRB type to at least one of the MN or the SN according to the information indicating the at least one of the MN leg or the SN leg in step 206. The QoE measurement reports may be the application layer measurement reports received from UE's higher layer, which are encapsulated in a transparent container and sent to the network, i.e., the at least one of the MN or SN in an application layer message, e.g., MeasurementReportAppLayer message. The UE can send multiple application layer measurement reports to the RAN node(s) in one MeasurementReportAppLayer message. In order to allow the transmission of application layer measurement reports exceeding the maximum PDCP SDU size, segmentation of the MeasurementReportAppLayer message (e.g., RRC segmentation) may be enabled by the RAN node.

As stated above, various SRB types can be used for QoE measurement reporting to the MN and SN. For example, in the case of SRB4 is used for QoE measurement reporting, the QoE measurement report is transmitted to the MN over the MN leg. In the case of SRB3 or SRB3-like is used for QoE measurement reporting, the QoE measurement report is transmitted to the SN over the SN leg. In the case of MN terminated split SRB4 or SN terminated split SRB4 is used for QoE measurement reporting and both the MN leg and the SN leg being used for QoE measurement reporting, the QoE measurement report is transmitted to the MN over the MN leg and to the SN over the SN leg. In the case of the MN terminated split SRB4 or the SN terminated split SRB4 is used for QoE measurement reporting while one of the MN leg and the SN leg being used for QoE measurement reporting, the QoE measurement report is transmitted to the corresponding one leg of the MN leg and the SN leg. For example, in the case of the MN terminated split SRB4 or the SN terminated split SRB4 is used for QoE measurement reporting while the MN leg being used for QoE measurement reporting, the QoE measurement report is transmitted to the MN leg.

In the case of the QoE measurement report is transmitted to both the MN and the SN, the RAN node in the network, e.g., the MN or SN may configure one of the MN leg and SN leg to be a primary leg and the other one of the MN leg and SN leg to be a secondary leg in some embodiments of the present application. In some other embodiments of the application, the MN or SN may configure one of the MN leg and SN leg with a higher priority than the other one. The UE will prioritize to transmit the QoE measurement report over the primary leg or over the leg with the higher priority of the MN leg and the SN leg.

In some embodiments of the present application, in the case of the QoE measurement report is transmitted to both the MN and the SN and RRC segmentation is used, the network side, e.g., the MN or SN may configure whether a part of RRC segments of the QoE measurement report is transmitted to the MN and other part of the RRC segments is transmitted to the SN is allowed and then transmit such an indication to the UE. The UE will transmit RRC segments of the QoE measurement report to one or both of the MN leg and SN leg according to the indication. For example, the UE will transmit RRC segments of the QoE measurement report to one of the MN leg and SN leg in the case that the indication indicating transmitting RRC segments of the QoE measurement report in different legs is not allowed, i.e. indicating a part of RRC segments of the QoE measurement report is transmitted to the MN and other part of the RRC segments is transmitted to the SN is not allowed. Otherwise, in the case the indication indicating transmitting RRC segments of the QoE measurement report in different legs is allowed, i.e. indicating a part of RRC segments of the QoE measurement report is transmitted to the MN and other part of the RRC segments is transmitted to the SN is allowed, the UE will transmit respective RRC segments of the QoE measurement report to the corresponding one of the MN and the SN.

A QoE measurement collection pause/resume procedure can be used to pause (and resume if possible) the reporting of all QoE measurement reports or to pause (and resume if possible) QoE measurement reporting per QoE configuration in the UE in the case of at least one of the MN or SN being in overload situation. Whether a RAN node, e.g., the MN or SN is overloaded for QoE measurement reporting can be determined based on a service type or a measurement configuration application layer identifier, e.g., measConfigAppLayerId. The network, e.g., the MN or SN may transmit a pause indication to the UE to pause QoE measurement reporting in the case of at least one of the MN or SN being overloaded for QoE measurement reporting, and then transmit a resume indication to the UE to resume the QoE measurement reporting if the at least one of the MN or SN is not overloaded for QoE measurement reporting.

For example, the MN may transmit a pause indication to the UE to pause QoE measurement reporting in the case of both the MN and SN are overloaded for QoE measurement reporting in some embodiments of the present application. In the case that none of the MN and the SN or only one of the MN and the SN is overloaded for the QoE measurement reporting, the MN may transmit a resume indication to the UE to resume the QoE measurement reporting.

In another example, the MN may transmit a pause indication to the UE to pause MN QoE measurement reporting (i.e. QoE measurement reporting via MN leg) in the case of the MN is overloaded for the QoE measurement reporting, and transmit a resume indication to the UE to resume the MN QoE measurement reporting after the MN is not overloaded for the QoE measurement reporting. The MN may also transmit a pause indication to the UE to pause SN QoE measurement reporting (i.e. QoE measurement reporting via SN leg) in response to a request of pause SN QoE measurement reporting from the SN, which is for all the QoE measurements, or for QoE measurement based on a service type or a measurement configuration application layer identifier, e.g., measConfigAppLayerId. Similarly, the MN may transmit a resume indication to the UE to resume the SN QoE measurement reporting in response to a request of resume SN QoE measurement reporting from the SN.

In some embodiments of the present application, the SN may indicate the UE to pause and resume the QoE measurement reporting in a manner similar to the MN. For example, the SN may transmit a pause indication to the UE to pause QoE measurement reporting of a leg of the RAN node, e.g., SN in response to the SN being overloaded for QoE measurement reporting, and transmit a resume indication to the UE to resume the SN QoE measurement reporting after the SN is not overloaded for QoE measurement reporting.

In some embodiments of the present application, the processor is configured to pause the QoE measurement reporting to the at least one of the MN and the SN in response to a pause indication to pause the QoE measurement reporting to the at least one of the MN and the SN. The processor is configured to resume QoE measurement reporting to the at least one of the MN and the SN in response to a resume indication to resume the QoE measurement reporting to the at least one of the MN and the SN.

Persons skilled in the art should well know that technical solutions of QoE measurement collection activation and reporting and technical solution of the QoE measurement collection pause/resume procedure illustrated in some embodiments of the present application are independent from each other. They can be applied together or applied with other technical solutions separately.

More detailed embodiment of the present application will be illustrated hereafter in view of some exemplary NR-DC scenarios.

In an exemplary NR-DC scenario (Scenario 1), the MN decides leg(s) for the QoE measurement reporting. FIG. 3 is a flow chart of a procedure of QoE measurement collection in Scenario 1 according to some embodiments of the present application.

Referring to FIG. 3, the MN may receive QoE measurement activation information, which may be QoE measurement activation signaling from the CN or QoE measurement configuration from the OAM. Accordingly, in step 301, the MN will decide the leg(s) used for the QoE measurement reporting. The MN will also decide the SRB type(s) used for the QoE measurement reporting. The QoE measurement reporting (or QoE measurement report) is at least one application layer measurement report received from UE's higher layer, which is encapsulated in a transparent container and sent to the network in the MeasurementReportAppLayer message.

For example, the MN may decide that the UE only sends the QoE measurement reporting over the MN leg directly. The MN may decide that the UE uses SRB4 for transmitting the QoE measurement reporting over the MN leg to the MN, which is similar to the QoE measurement reporting in Rel-17.

In another example, the MN may decide that the UE only sends the QoE measurement reporting over the SN leg. The MN may decide that the UE uses MN terminated split SRB4 or SN terminated split SRB4 or SRB3 or SRB3-like for transmitting the QoE measurement reporting over the SN leg.

In another example, the MN may decide that the UE sends the QoE measurement reporting over both the MN leg and SN leg. In this case, the UE will select the reporting leg, e.g., the MN leg or SN leg based on a configured rule. The MN may decide that the UE uses MN terminated split SRB4, SN terminated split SRB4 or SRB4 for transmitting the QoE measurement reporting over the MN leg, and use MN terminated split SRB4, SN terminated split SRB4, SRB3 or SRB3-like for transmitting the QoE measurement reporting over the SN leg.

In some other embodiments of the present application (not limited to Scenario 1), the MN may decide to which RAN node, e.g., the MN or the SN, the QoE measurement reporting is transmitted and decide the SRB type used for transmitting the QoE measurement reporting. For example, the MN may decide that the UE uses SRB4 for transmitting the QoE measurement reporting to the MN directly, or the UE uses SRB3 or SRB3-like for transmitting the QoE measurement reporting to the SN directly. In another example, the MN may decide that the UE uses MN terminated split SRB4 for transmitting the QoE measurement reporting to the MN, which may be over the MN leg and/or SN leg (i.e., at least one of the MN leg and SN leg). When the UE transmits the QoE measurement reporting to the SN over the SN leg, the SN will forward the received QoE measurement reporting to the MN, e.g., over Xn interface. Similarly, the MN may decide that the UE uses SN terminated split SRB4 for transmitting the QoE measurement reporting to the SN, which may be over the MN leg and/or SN leg. When the UE transmits the QoE measurement reporting to the MN over the MN leg, the MN will forward the received QoE measurement reporting (e.g. the PDCP PDU of the QoE measurement reporting) to the SN, e.g., over Xn interface.

In the case that SN leg is configured for transmitting the QoE measurement reporting, the MN will transmit a request of SRB establishment of a corresponding SRB type for the QoE measurement reporting to the SN in step 303. For example, in the case that the MN decides that the UE uses MN terminated split SRB4, or SN terminated split SRB4 or SRB3 or SRB3-like, e.g., SRB5 for transmitting the QoE measurement reporting over the SN leg, the MN will indicate the request SRB type to the SN so that the SN can establish the SRB for transmitting the QoE measurement reporting. The MN may also send the service type or measurement configuration application layer identifier, e.g., measConfigAppLayerId of the QoE measurement reporting to the SN to support per service type or measConfigAppLayerId configuration. In the case of per service type, for different service types, the QoE measurement reporting may be configured in different manners. Similarly, in the case of per measurement configuration application layer identifier, for different measurement configuration application layer identifiers, the QoE measurement reporting may be configured in different manners.

The request of SRB type establishment can be included in a Xn message during a SN addition procedure or after the SN addition procedure. For example, the request of SRB type establishment can be included in Xn-AP S-Node Addition Request message in the SN addition procedure or included in Xn-AP S-Node Modification Request message after the SN addition procedure.

In response to the request of SRB establishment, the SN may send the admitted SRB type, e.g., MN terminated split SRB4, or MN terminated split SRB4, or SRB3 or SRB3-like to the MN in step 305, e.g., in Xn-AP S-Node Addition Acknowledge in the SN addition procedure or S-Node Modification Request Acknowledge message after the SN procedure. In step 307, there will be a SRB establishment for QoE measurement reporting between the SN and UE similar to the legacy technology to establish the admitted SRB type.

In step 309, the MN will send the information indicating the leg(s) for QoE measurement reporting (also referred to as “QoE measurement reporting leg indication”) to the UE. The QoE measurement reporting leg indication can be provided together with QoE measurement configuration, which is in RRCReconfiguation message. In some other embodiments of the present application, the MN may transmit the information indicating to which RAN node, e.g., the MN or SN, the UE will transmit the QoE measurement reporting.

The QoE measurement reporting indication may explicitly indicate the QoE measurement reporting is only reported over the MN leg, or only reported over the SN leg, or reported over both the MN leg and SN leg. The corresponding SRB type, e.g., reporting over the SN leg by SRB3 or reporting over the MN leg by SRB4 will be further indicated to the UE (which may also be included in the QoE measurement configuration, e.g., RRCReconfiguation message). In some other embodiments of the present application, the QoE measurement reporting indication may be implicitly indicated, e.g., by indicating the SRB type configured for transmitting the QoE measurement reporting. For example, in the case that SRB3 is configured, the UE is expected to send the QoE measurement reporting by SRB3 over the SN leg. In another example, in the case that MN terminated split SRB4 is configured, the UE is expected to send the QoE measurement reporting sent by MN terminated split SRB4 over both the MN leg and SN leg.

In step 311, the UE will send the QoE measurement reporting (or QoE measurement report) to the network side according to the QoE measurement reporting leg indication (or the information indicating to which RAN node the QoE measurement reporting is transmitted). When the QoE measurement reporting is at least one application layer measurement report received from UE's higher layer encapsulated in a transparent container, the UE will send the QoE measurement reporting to the network in MeasurementReportAppLayer message.

For example, in the case that the QoE measurement reporting is configured to be transmitted by SRB4 over the MN leg, the UE will send the QoE measurement reporting to the MN over the MN leg. If the RRC segmentation is used, the UE will send all RRC segments of the QoE measurement reporting over the MN leg to the MN.

In the case that the QoE measurement reporting is configured to be transmitted to the SN by MN terminated split SRB4, SN terminated split SRB4, SRB3 or SRB3-like, the UE will send the QoE measurement reporting or all RRC segments of the QoE measurement reporting over the MN leg and/or SN leg via MN terminated split SRB4, SN terminated split SRB4, SRB3 or SRB3-like.

In the case that the QoE measurement reporting is configured to be transmitted via the MN terminated split SRB4 or SN terminated split SRB4 over both the MN leg and SN leg, a primary leg and a secondary leg of the MN leg and SN leg may be configured to the UE. The UE will prioritize to transmit the QoE measurement reporting over the primary leg as the legacy. In some embodiments of the present application, different priorities may be configured for the MN leg and SN leg, and the UE will prioritize to transmit the QoE measurement reporting over the leg with the higher priority.

In some embodiments of the present application, if the QoE measurement reporting is configured to be transmitted over the SRB4 over the MN leg (or configured to be transmitted to the MN) and SRB3 or SRB3-like over the SN leg (or configured to be transmitted to the SN), the network side may also configure whether to allow a part of RRC segments transmitted over the MN leg (or to the MN) and the other part of the RRC segments over the SN leg (or to the SN). If it is not allowed, the UE will transmit all RRC segments of the QoE measurement reporting over one of the MN leg and SN leg. Similarly, the network side, e.g., the MN or SN may also configure priorities of the two legs (or two RAN nodes), so that the UE can prioritize to transmit the QoE measurement reporting to the leg with a higher priority. If the leg with the higher priority is not available or unable to transmit the QoE measurement reporting, e.g., being overload, the UE will use the leg with a lower priority.

In the case that MN terminated split SRB4 is used, the SN needs to forward the received QoE measurement or partial or all RRC segments to the MN. In the case of SN terminated split SRB4 is used, the MN needs to forward the received PDCP PDU of the QoE measurement reporting or partial or all PDCP PDUs of RRC segments of the QoE measurement reporting to the SN. Whatever, in the case that the SN receives the PDCP PDU of QoE measurement reporting, or partial or all PDCP PDUs of RRC segments of the QoE measurement reporting over the SN leg over Uu interface, the SN will forward the received PDCP PDU of QoE measurement reporting or PDCP PDUs of the RRC segments of the QoE measurement reporting to the MN over Xn interface in step 313, so that the MN can transmit the whole QoE measurement reporting to the OAM or CN.

For example, after receiving the RRC segments of the QoE measurement reporting via MN terminated split SRB4, or SN terminated split SRB4, or SRB3 or SRB3-like, the SN may concatenate all the RRC segments to the whole QoE measurement reporting, e.g., the MeasurementReportAppLayer and send the concatenated QoE measurement reporting to the MN. In another example, after receiving the RRC segments of the QoE measurement reporting via MN terminated split SRB4, or SN terminated split SRB4, or SRB3 or SRB3-like, the SN may forward all received RRC segments to the MN via a Xn message. The SN will also forward the RRC segment indexes together with the received RRC segments to the MN via the Xn message. Compared with the legacy message, the Xn message may be a new Xn message, e.g., named as “RRC segmentation Transfer” message introduced for RRC segmentation delivery between the MN and the SN. The MN will concatenate all the RRC segments to the QoE measurement reporting.

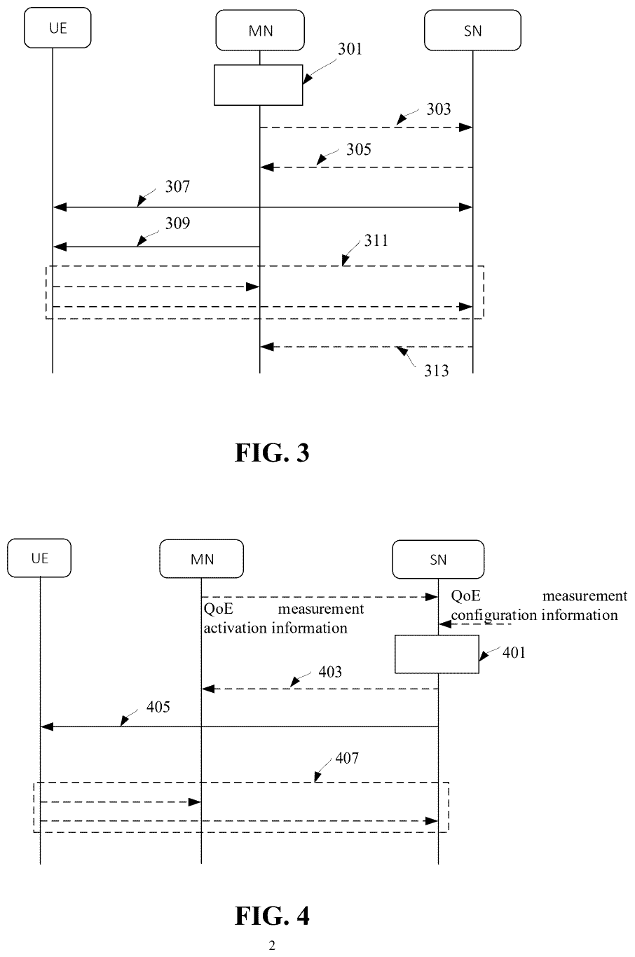

In another NR-DC scenario (Scenario 2), the SN rather than the MN decides the leg(s) used for QoE measurement reporting. FIG. 4 is a flow chart of a procedure of QoE measurement collection in Scenario 2 according to some embodiments of the present application.

Referring to FIG. 4, in step 401, the SN may decide at least one of the MN leg or the SN leg to be used for QoE measurement reporting in response to QoE measurement activation information from the MN (signalling based QoE measurement) or QoE measurement configuration information from the OAM (management-based QoE measurement).

In the case of signalling based QoE measurement, the MN receives the QoE measurement activation signalling from the CN, and then requests the SN to provide QoE measurement configuration to the UE by transmitting the QoE measurement activation information, e.g., in S-Node Addition Request message or S-Node Modification Request message. The MN may also include the UE QoE measurement capability in the message. The QoE measurement activation information may include QoE reference, service type, measurement collection entity (MCE) internet protocol (IP) address, slice scope, area scope, or minimization of drive tests (MDT), alignment information and the indication of available RAN visible QoE metrics etc. The MN may also send requested SRB type, e.g., SRB3 for the QoE measurement configuration indication to the SN in some embodiments of the present application.

In the case of management based QoE measurement, the SN may receive the QoE measurement configuration from OAM. The SN may select the UE for QoE measurement collection after receiving the QoE measurement configuration.

The SN will also decide the SRB type for the QoE measurement reporting. Similarly, in the case that the MN leg may be used, the SN will send a request of SRB establishment of a corresponding SRB type for QoE measurement reporting to the MN in step 403. For example, the SN may decide to use SN terminated split SRB4 and send the request of SN terminated split SRB establishment to the MN.

The SN will send the information indicating the leg(s) for QoE measurement reporting, i.e., QoE measurement reporting leg indication to the UE in step 405, e.g., via SRB3. Similarly, the QoE measurement reporting leg indication can be provided together with QoE measurement configuration, which is in RRCReconfiguation message. In some other embodiments of the present application, the SN may transmit the information indicating to which RAN node, e.g., the MN or SN, the UE will transmit the QoE measurement reporting.

The QoE measurement reporting indication may explicitly indicate the QoE measurement reporting is only reported over the MN leg, or only reported over the SN leg, or reported over both the MN leg and SN leg. In some other embodiments of the present application, the QoE measurement reporting indication may be implicitly indicated, e.g., by indicating the SRB type configured for transmitting the QoE measurement reporting. For example, in the case that SN terminated split SRB4 is configured, the UE will treat the QoE measurement reporting to be sent over the SN terminated split SRB via the MN leg and SN leg.

In step 407, the UE will send the QoE measurement reporting to the network side, e.g., the MN and/or SN according to the QoE measurement reporting leg indication (or the information indicating to which RAN node the QoE measurement reporting is transmitted). For example, in the case of SN terminated split SRB4 is indicated, the UE may transmit the QoE measurement reporting (or partial or all RRC segments of the QoE measurement reporting) to the MN via the MN leg and to the SN via the SN leg. However, after receiving the PDCP PDUs of the QoE measurement reporting, the MN will forward the received PDCP PDUs to the SN via Xn signalling, e.g., RRC Transfer message in the case of SN terminated split SRB4 being used.

After receiving the QoE measurement reporting, the SN will transmit it to the MN in the case of signalling-based QoE measurement, so that the MN can report the QoE measurement reporting to the CN. In the case of management-based QoE measurement, the SN will transmit the QoE measurement reporting to the QAM.

Compared with Scenario 1, descriptions on Scenario 2 are simplified to avoid unnecessary duplication. Persons skilled in the art should well know that details illustrated in Scenario 1 can also be applied to Scenario 2 in the same or similar way.

Scenario 3 and Scenario 4 are related to the QoE measurement collection pause/resume procedure. In Scenario 3, the MN configures the QoE measurement collection pause/resume indication taking the SN QoE measurement reporting overload information into account. While in Scenario 4, the MN and SN decide their own QoE measurement reporting pause/resume indication, that is, separate pause/resume indication of the QoE measurement reporting per leg is configured.

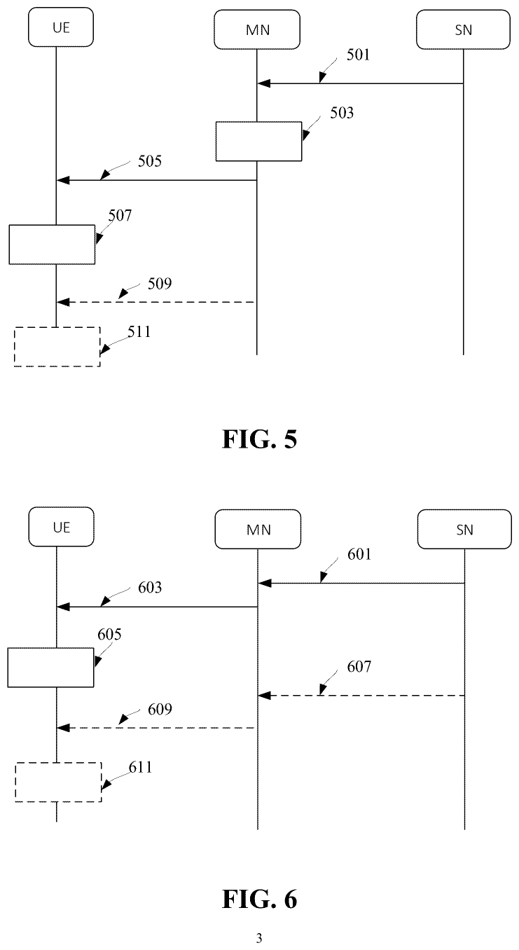

FIG. 5 is a flow chart of a procedure of QoE measurement collection in Scenario 3 according to some embodiments of the present application.

Referring to FIG. 5, in step 501, the SN may send SN QoE measurement reporting overload information to the MN over Xn interface, which may be periodically or event-triggered transmitted. The SN QoE measurement reporting overload information may be an explicit indication to indicate the QoE measurement reporting overload status in the SN, such as with an overload status of ‘high’ ‘medium’ and ‘low.’ The SN QoE measurement reporting overload information may be per service type or per measurement configuration application layer identifier, e.g., measConfigAppLayerId. The service type may indicate service type of QoE measurements such as virtual reality (VR), multicast and broadcast service (MBS) etc. In the case of the SN QoE measurement reporting overload information being per service type, the service type will be included in the SN QoE measurement reporting overload information. In the case of the SN QoE measurement reporting overload information being per measConfigAppLayerId, the measConfigAppLayerId will be included in the SN QoE measurement reporting overload information. In another example, the SN QoE measurement reporting overload information may be an implicit indication. The MN can infer the SN QoE measurement reporting overload status according to the information provided in Xn user plane protocol, e.g., the flow control information. The MN can also infer the SN QoE measurement reporting overload status according to the information provided by load information.

In step 503, the MN will decide to pause to the QoE measurement reporting in response to both the MN and the SN are overloaded for QoE measurement reporting. The MN will transmit a pause indication (e.g., RRC configuration) to the UE, e.g., by setting a parameter “pauseReporting” to true, and send it to the UE in step 505.

After receiving the pause indication, the UE will pause the QoE measurement reporting on both the MN leg and the SN leg in step 507. For example, the SN QoE measurement reporting overload information is per measConfigAppLayerId and RRC segmentation is enabled in some embodiments of the present application. If at least one segment of a segmented MeasurementReportAppLayer message containing an application layer measurement report associated with the measConfigAppLayerId has been submitted to lower layers of the two DC legs for transmission, while has not been to the network side, then the UE will submit the at least one segment of the MeasurementReportAppLayer message to lower layers for transmission. The UE will submit the remaining segments of the MeasurementReportAppLayer message to lower layers for transmission. The UE will suspend submitting application layer measurement report containers to lower layers for the application layer measurement configuration associated with the measConfigAppLayerId. In addition, the UE will store any previously or subsequently received application layer measurement report containers associated with the measConfigAppLayerId for which no segment, or the entire QoE measurement reporting, has been submitted to lower layers for transmission.

In step 507, the MN may decide to resume to the QoE measurement reporting if either the MN or the SN is not overloaded for QoE measurement reporting or both of them are not overloaded for QoE measurement reporting. For example, the MN may receive the SN QoE measurement reporting overload information indicating that the SN is not overloaded for QoE measurement reporting. The MN will send a resume indication to the UE to resume the QoE measurement reporting, e.g., setting the parameter “pauseReporting” to false and send it to UE in step 509.

Then, after receiving the resume indication, e.g., pauseReporting set to false, the UE will resume the QoE measurement reporting in step 511. For example, the UE will submit application layer measurement report containers to lower layers for the application layer measurement configuration associated with the measConfigAppLayerId.

FIG. 6 is a flow chart of a procedure of QoE measurement collection in Scenario 4 according to some embodiments of the present application.

Referring to FIG. 6, separate pause/resume indication of the QoE measurement reporting per leg is configured in Scenario 4. The UE will only pause or resume the QoE measurement reporting on the corresponding leg.

Taking the SN as an example, the SN may decide to pause the QoE measurement reporting according to its own QoE measurement reporting overload status. In step 601, the SN may send a request of pause SN QoE measurement reporting to the MN in the case that the SN decides to pause the QoE measurement reporting. Similarly, the request of pause SN QoE measurement reporting may be per service type or per measConfigAppLayerId. In the case of the request of pause SN QoE measurement reporting being per service type, the service type will be included in the request of pause SN QoE measurement reporting. In the case of the SN QoE measurement reporting overload information being per measConfigAppLayerId, the measConfigAppLayerId will be included in the request of pause SN QoE measurement reporting.

After the MN receives the request of pause SN QoE measurement reporting from the SN, the MN will send a pause indication (e.g., RRC configuration) to the UE to pause the QoE measurement to the SN. For example, the MN may set pauseReportingSN to true, and send it to the UE in step 603.

After receiving the pauseReportingSN set to true, the UE will pause the QoE measurement reporting on the SN leg in step 605. For example, the request of pause SN QoE measurement reporting is per measConfigAppLayerId and RRC segmentation is enabled in some embodiments of the present application. If at least one segment of a segmented MeasurementReportAppLayer message containing an application layer measurement report associated with the measConfigAppLayerId has been submitted to lower layers of the SN leg for transmission, while has not been to the network side, then the UE will submit the at least one segment of the MeasurementReportAppLayer message to lower layers of the SN leg for transmission. The UE will submit the remaining segments of the MeasurementReportAppLayer message to lower layers of the SN for transmission. The UE will suspend submitting application layer measurement report containers to lower layers of the SN leg for the application layer measurement configuration associated with the measConfigAppLayerId. In addition, the UE will store any previously or subsequently received application layer measurement report containers associated with the measConfigAppLayerId for which no segment, or the entire QoE measurement reporting, has been submitted to lower layers of the SN leg for transmission.

The SN will decide whether to resume the QoE measurement reporting according to its own QoE measurement reporting overload status, which may be per service type or per measConfigAppLayerId. Similarly, the SN will send the request of resume SN QoE measurement reporting to the MN in step 607 if the SN QoE measurement reporting is not overloaded. The request of resume SN QoE measurement reporting may include the service type or measConfigAppLayerId in the case of per service type or per measConfigAppLayerId respectively.

When the MN receives the request of resume SN QoE measurement reporting from the SN, the MN will send a resume indication to the UE in step 609 to resume the SN QoE measurement reporting, e.g., setting pauseReportingSN to false, and send it to UE.

In step 611, the UE will resume the QoE measurement reporting on the SN leg after receiving pauseReportingSN set to false. For example, the UE will resume submitting application layer measurement report containers to lower layers of SN leg for the application layer measurement configuration associated with the measConfigAppLayerId.

Similar to the SN, the MN can pause and resume the QoE measurement report on MN leg based on its own QoE measurement reporting overload status. Similar handling as illustrated above can also be applied to the MN leg.

In some other embodiments of the present application, the SN can generate the indication (e.g., RRC configuration or medium access control (MAC) control element (CE)) of pause or resume the QoE measurement report on the SN leg itself. The SN can send the RRC configuration of pause or resume the QoE measurement report on the SN leg directly to UE via SRB3 or to the MN by RRC container so that the MN can forward it to the UE.

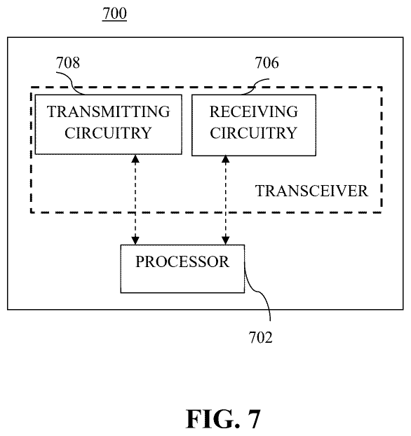

Besides methods, embodiments of the present application also propose an apparatus of supporting QoE measurement collection. FIG. 7 is a block diagram of an apparatus of supporting QoE measurement collection according to some embodiments of the present application.

Referring to FIG. 7, the apparatus 700, e.g., a UE or a RAN node may include at least one processor 702 and at least one transceiver 704. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a RAN node, e.g., a MN or SN, the processor is configured to: receive, via the transceiver, information indicating at least one of a MN leg or a SN leg to be used for QoE measurement reporting; and transmit to at least one of a MN or a SN a QoE measurement report via at least one SRB type according to the information indicating the at least one of the MN leg or the SN leg.

According to some other embodiments of the present application, when the apparatus 700 is a UE, the processor may be configured to: determine at least one of a MN leg or a SN leg to be used for QoE measurement reporting; and transmit, via the transceiver, to a UE information indicating the at least one of the MN leg or the SN leg to be used for QoE measurement reporting.

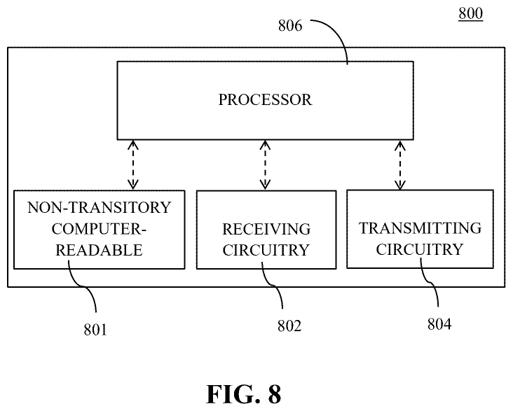

For example, FIG. 8 illustrates a block diagram of an apparatus 800 of supporting QoE measurement reporting according to some other embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a RAN node or a terminal device (e.g., a UE) configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. The processor 806 may be a CPU, a DSP, a microprocessor etc. In certain embodiments of the present application, the apparatus 800 may further include an input device, a memory, and/or other components.

In some embodiments of the present application, the non-transitory computer-readable medium 801 may have stored thereon computer-executable instructions to cause the processor 806 to implement the method with respect to the RAN node, e.g., a MN or SN as described above. For example, the computer-executable instructions, when executed, cause the processor 806 interacting with receiving circuitry 802 and transmitting circuitry 804, so as to perform the steps with respect to a RAN node as depicted above.

In some embodiments of the present application, the non-transitory computer-readable medium 801 may have stored thereon computer-executable instructions to cause a processor to implement the method with respect to the terminal device as described above. For example, the computer-executable instructions, when executed, cause the processor 806 interacting with receiving circuitry 802 and transmitting circuitry 804, so as to perform the steps with respect to a UE as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A radio access network (RAN) node for wireless communication, comprising:
at least one memory; and
at least one processor coupled with the at least one memory and configured to cause the RAN node to:
determine at least one of a master node (MN) leg or a secondary node (SN) leg to be used for quality of experience (QoE) measurement reporting; and
transmit, to a user equipment (UE), information indicating the at least one of the MN leg or the SN leg to be used for the QoE measurement reporting.

2. The RAN node of claim 1, wherein the RAN node is an MN, and wherein the at least one processor is further configured to cause the RAN node to: determine at least one signaling radio bearer (SRB) type for QoE measurement reporting in response to QoE measurement activation information from a core network or QoE measurement configuration information from an operation administration and maintenance (OAM).

3. The RAN node of claim 2, wherein, when the SN leg is used for QoE measurement reporting, the at least one processor is further configured to cause the RAN node to: transmit to an SN a request of SRB establishment of a corresponding SRB type for QoE measurement reporting.

4. The RAN node of claim 3, wherein the at least one SRB type includes one of an MN terminated split SRB4, an SN terminated split SRB4, an SRB3, and an SRB terminated between the UE and the SN for QoE measurement reporting with a lower priority than the SRB3.

5. The RAN node of claim 1, wherein the RAN node is a SN, and wherein the at least one processor is further configured to cause the RAN node to: determine at least one signaling radio bearer (SRB) type for QoE measurement reporting in response to QoE measurement activation information from an MN or QoE measurement configuration information from an operation administration and maintenance (OAM).

6. The RAN node of claim 5, wherein the at least one SRB type includes one of an MN terminated split SRB4, an SN terminated split SRB4, an SRB3, or an SRB terminated between the UE and the SN for QoE measurement reporting with a lower priority than the SRB3.

7. The RAN node of claim 6, wherein the at least one processor is further configured to cause the RAN node to: transmit a request of an SN terminated split SRB establishment to the MN when the SN terminated split SRB4 is used for QoE measurement reporting.

8. The RAN node of claim 1, wherein the information indicating the at least one of the MN leg or the SN leg to be used for QoE measurement reporting is separate from information on at least one signaling radio bearer (SRB) type or is indicated in the information on the at least one SRB type.

9. The RAN node of claim 1, wherein the RAN node is an MN, and wherein the at least one processor is further configured to cause the RAN node to: transmit a pause indication to the UE to pause QoE measurement reporting when both the MN or the SN are overloaded for QoE measurement reporting.

10. The RAN node of claim 9, wherein the at least one processor is further configured to cause the RAN node to: receive QoE measurement reporting overload information from the SN.

11. The RAN node of claim 1, wherein the RAN node is an MN, and wherein the at least one processor is further configured to cause the RAN node to: transmit a pause indication to the UE to pause SN QoE measurement reporting in response to a request to pause the SN QoE measurement reporting.

12. A user equipment (UE) for wireless communication, comprising:
at least one memory; and
at least one processor coupled with the at least one memory and configured to cause the UE to:
receive information indicating at least one of a master node (MN) leg or a secondary node (SN) leg to be used for quality of experience (QoE) measurement reporting; and
transmit to at least one of an MN or an SN a QoE measurement report via at least one signaling radio bearer (SRB) type according to the information indicating the at least one of the MN leg or the SN leg.

13. The UE of claim 12, wherein,
when an SRB4 is used for QoE measurement reporting, the QoE measurement report is transmitted to the MN by using the MN leg;
when an SRB3 or an SRB terminated between the UE and the SN for QoE measurement reporting with a lower priority than the SRB3 is used for QoE measurement reporting, the QoE measurement report is transmitted to the SN over the SN leg;
when an MN terminated split SRB4 or an SN terminated split SRB4 is used for QoE measurement reporting and both the MN leg and the SN leg are used for QoE measurement reporting, the QoE measurement report is transmitted to the MN over the MN leg and to the SN over the SN leg; and
when the MN terminated split SRB4 or the SN terminated split SRB4 is used for QoE measurement reporting and one of the MN leg and the SN leg is used for QoE measurement reporting, the QoE measurement report is transmitted to the MN and the SN over the MN leg and the SN leg.

14. The UE of claim 12, wherein the at least one processor is further configured to cause the UE to: pause QoE measurement reporting to the at least the MN and the SN in response to a pause indication to pause the QoE measurement reporting to the at least the Mn and the SN.

15. A method performed by a network node, comprising:
determining at least one of a master node (MN) leg or a secondary node (SN) leg to be used for quality of experience (QoE) measurement reporting; and
transmitting, to a user equipment (UE), information indicating the at least one of the MN leg or the SN leg to be used for the QoE measurement reporting.

16. The method of claim 15, wherein the network node is an MN, further comprising: determining at least one signaling radio bearer (SRB) type for QoE measurement reporting in response to receiving QoE measurement activation information from a core network or receiving QoE measurement configuration information from an operation administration and maintenance (OAM).

17. The method of claim 15, wherein the network node is an SN, further comprising: determining at least one signaling radio bearer (SRB) type for QoE measurement reporting in response to receiving QoE measurement activation information from an MN or receiving QoE measurement configuration information from an operation administration and maintenance (OAM).

18. The method of claim 15, further comprising: receiving QoE measurement reporting overload information from the SN.

19. The method of claim 15, wherein the RAN node is an MN, further comprising: transmitting a pause indication to the UE to pause SN QoE measurement reporting in response to a request to pause the SN QoE measurement reporting.

20. A processor for wireless communication, comprising:
at least one controller coupled with the at least one memory and configured to cause the processor to:
receive information indicating at least one of a master node (MN) leg or a secondary node (SN) leg to be used for quality of experience (QoE) measurement reporting; and
transmit to at least one of an MN or an SN a QoE measurement report via at least one signaling radio bearer (SRB) type according to the information indicating the at least one of the MN leg or the SN leg.
